(19) United States
(12) Patent Application Publication
(10) Pub. No.: US 2026/0316669 A1
(43) Pub. Date: Oct. 15, 2026

(54) U-TURN SIGNAL FOR A MOVING VEHICLE

(71) Applicant: Vivianna F. BRINK, Wallkill, NY (US)

(72) Inventors: Vivianna F. BRINK, Wallkill, NY (US); Ivan RIVAS, Hurleyville, NY (US); Jose DUENAS, Clemont, FL (US)

(73) Assignee: Vivianna F. BRINK, Wallkill, NY (US)

(21) Appl. No.: 19/679,424

(22) Filed: May 15, 2026

Related U.S. Application Data
(63) Continuation-in-part of application No. 18/979,778, filed on Dec. 13, 2024, now abandoned.
(60) Provisional application No. 63/611,571, filed on Dec. 18, 2023.

(51) Int. Cl. B60Q 1/34; B60Q 9/00

(52) U.S. Cl. CPC B60Q 1/343; B60Q 9/008; B60Q 2900/30

(57) ABSTRACT

In at least one embodiment there is a moving vehicle turn signal comprising a housing, a light, a switch to selectively turn on or off the light, a display indicating a turn arrow for indicating a U-turn; and a controller for activating the switch for selectively switching on the light. In at least one embodiment there is a housing that has a backing and sides which are reflective and a front surface that is at least partially translucent. In at least one embodiment the housing is substantially rectangular in shape. In at least one embodiment the light is a LED light. In at least one embodiment the controller is in wired communication with the switch. In at least one embodiment the controller is in wireless communication with the switch. In at least one embodiment the display is formed from the light positioned in a substantially J-shape.

### CROSS REFERENCE TO RELATED APPLICATIONS

This application is a continuation in part application of U.S. patent application Ser. No. 18/979,778 filed on Dec. 13, 2024, which claims priority from provisional application Ser. No. 63/611,571 filed on Dec. 18, 2023, the disclosure of all of these applications hereby incorporated herein by reference in its entirety.

### BACKGROUND OF THE INVENTION

Vehicles that have to make frequent U-turns are put into a position to be vulnerable to other oncoming traffic or adjacent moving traffic which may not understand the intention of the driver intending to make a U-turn. Presently there are turn signals which only indicate the intention to turn, such as turning in a 90-degree manner. However, it is believed that there is no current U-turn signal or signal system which indicates the intention or action of a driver who will attempt or who is currently attempting a U-turn.

### SUMMARY

In at least one embodiment there is a moving vehicle turn signal comprising a housing, a light, a switch to selectively turn on or off the light, a display indicating a turn arrow for indicating a U-turn; and a controller for activating the switch for selectively switching on the light. In at least one embodiment there is a housing that has a backing and sides which are reflective and a front surface that is at least partially translucent. In at least one embodiment the housing is substantially rectangular in shape. In at least one embodiment the light is an LED light. In at least one embodiment the controller is in wired communication with the switch. In at least one embodiment the controller is in wireless communication with the switch. In at least one embodiment, the display is coupled to the housing. In at least one embodiment, the display is formed from the light positioned in a substantially J-shape. In at least one embodiment, the display has a translucent section that is formed in a substantially J-shape. In at least one embodiment, the housing is positioned on a back window of a moving vehicle. In at least one embodiment, the housing is positioned on or adjacent to a license plate on a moving vehicle. For purposes of this application, the term “substantially J shape” means a shape suitable to resemble a letter J. In at least one embodiment, the housing is positioned on a windshield of a moving vehicle. In at least one embodiment, the housing is positioned on a side panel of the moving vehicle. In at least one embodiment, the housing is positioned on a fender of the moving vehicle. In at least one embodiment, the housing is positioned on the roof of the moving vehicle.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A is a schematic electrical block diagram of the circuit of the U-turn indicator;

FIG. 1B is a diagram of the electrical connector of the U-turn indicator;

FIG. 1C is a schematic block diagram of the circuit for the U-turn indicator;

FIG. 1D is a diagram of the electrical connector for the U-turn indicator; connector for the U-turn indicator;

FIG. 2A is a view of the steering wheel and actuator of the U-turn indicator;

FIG. 2B is a view of the steering wheel and actuator of the U-turn indicator;

FIG. 3 is the flow chart for the process for actuating the U-turn indicator;

FIG. 4A is a front view of a U-turn indicator;

FIG. 5A is a first view of a positioning of a dashboard U-turn indicator;

FIG. 5B is a second view of a positioning of a dashboard of a U-turn indicator;

FIG. 5C is a third view of a positioning of a dashboard of a U-turn indicator;

FIG. 6A is a first view of the positioning of the U-turn indicator;

FIG. 6B is a second view of a positioning of a U-turn indicator;

FIG. 6C is a third view of a positioning of a U-turn indicator;

FIG. 6D is another embodiment of a rear view of an auto;

FIG. 7A is another view of a positioning of a U-turn indicator;

FIG. 7B is another view of a positioning of a U-turn indicator;

FIG. 7C is another view of a positioning of a U-turn indicator;

FIG. 8A is another view of a positioning of a U-turn indicator;

FIG. 8B is another view of a positioning of a U-turn indicator;

FIG. 8C is another view of a positioning of a U-turn indicator;

FIG. 8D is another view of a U-turn indicator;

FIG. 8E is another view of a U-turn indicator;

FIG. 9 is a flow chart for the process for initiating the U-turn indicator;

FIG. 10 is a view of a housing of a U-turn indicator;

FIG. 11 is a view of a circuit for colored indication or color changes;

FIG. 12 is a view of the light system in communication with an annunciator and communication module; and

FIG. 13 is a view of another mechanism for displaying a U-turn signal either in the front windshield or the back windscreen;

FIG. 14 is an array of ultrasonic transducers;

FIG. 15 is a rear view showing four ultrasonic transducers;

FIG. 16 is a cross section of a housing;

FIG. 17A is a motherboard detail view;

FIG. 17B is a flow chart for tracking with the accelerometer;

FIG. 18A is a motherboard for the GPS;

FIG. 18B is a flow chart for using the GPS;

FIG. 19A is a steering wheel showing a haptic motor; and

FIG. 19B is a chart showing the indications created by the haptic motor.

### DETAILED DESCRIPTION

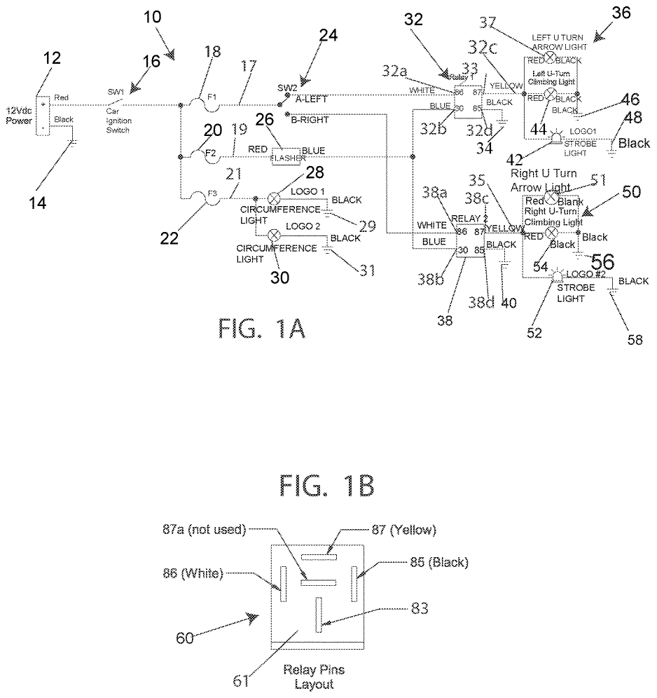

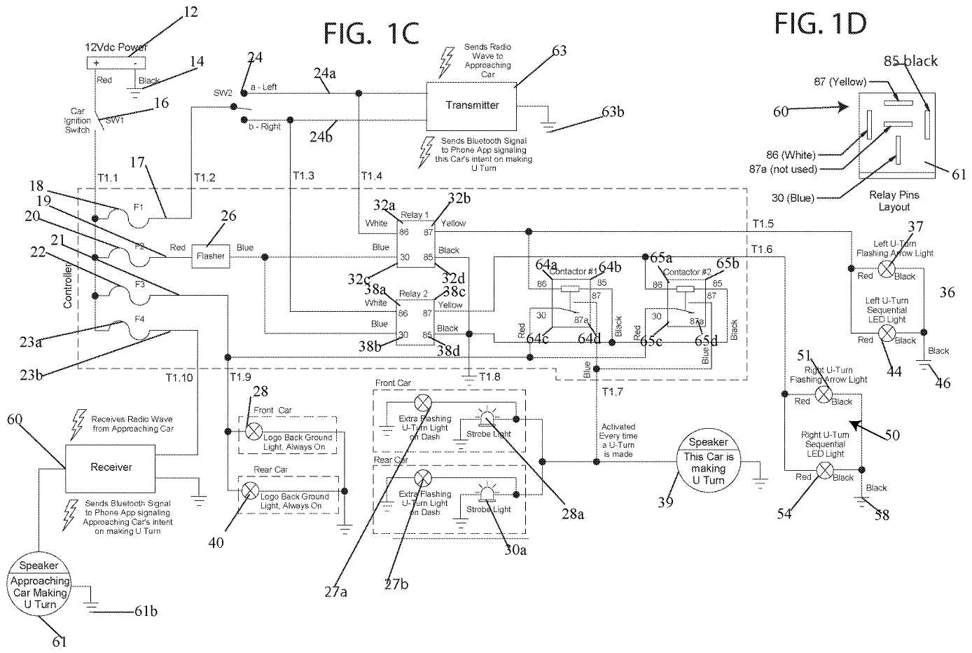

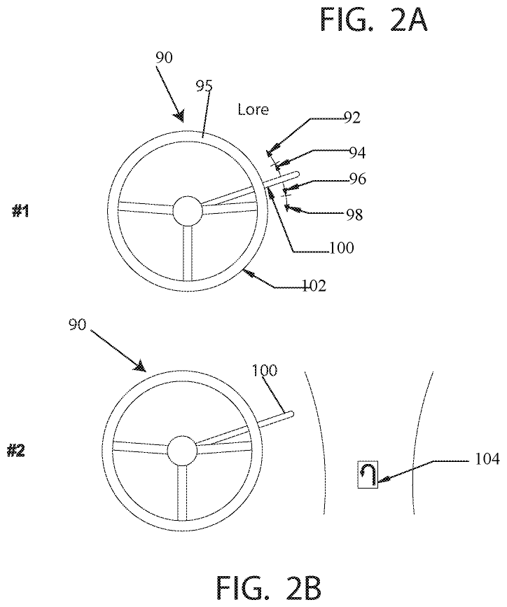

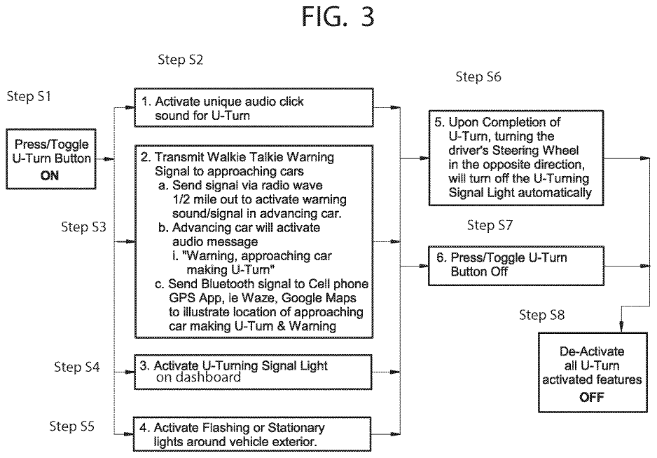

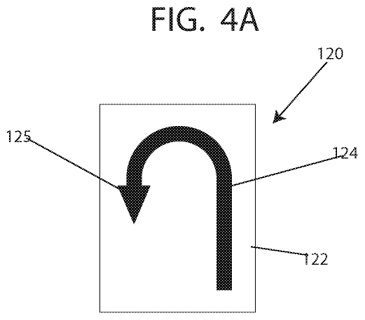

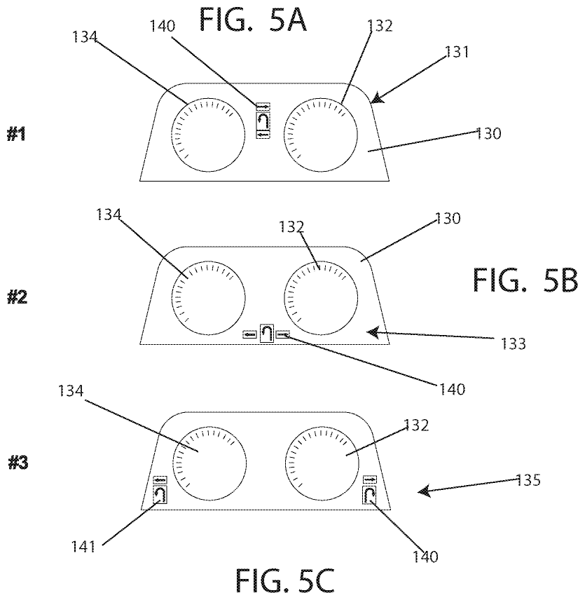

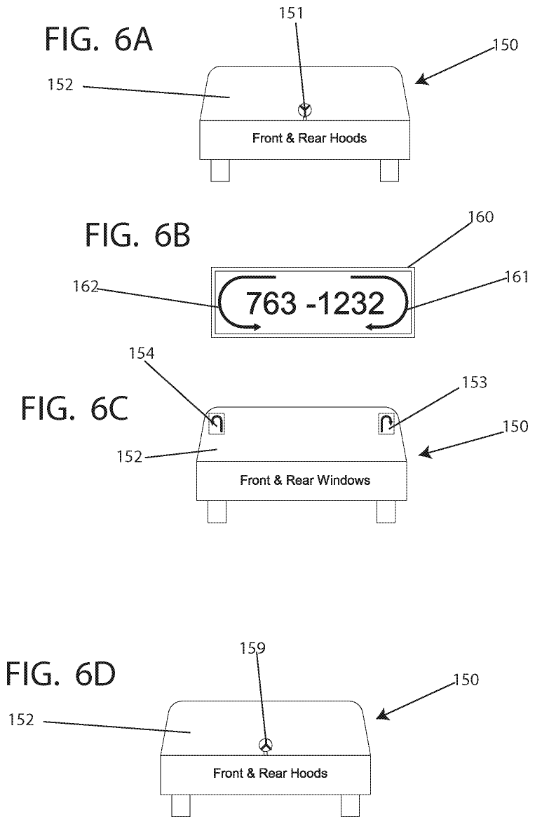

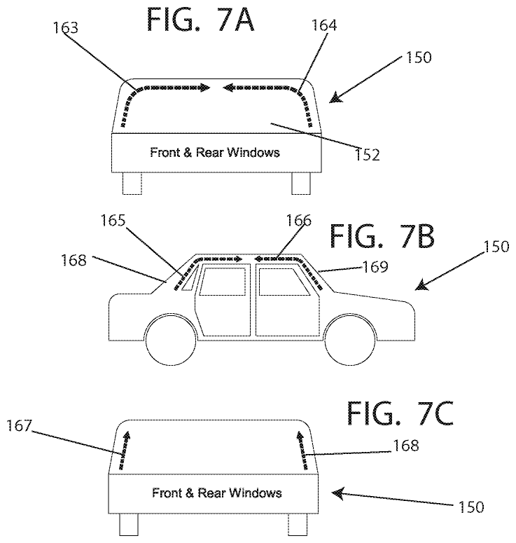

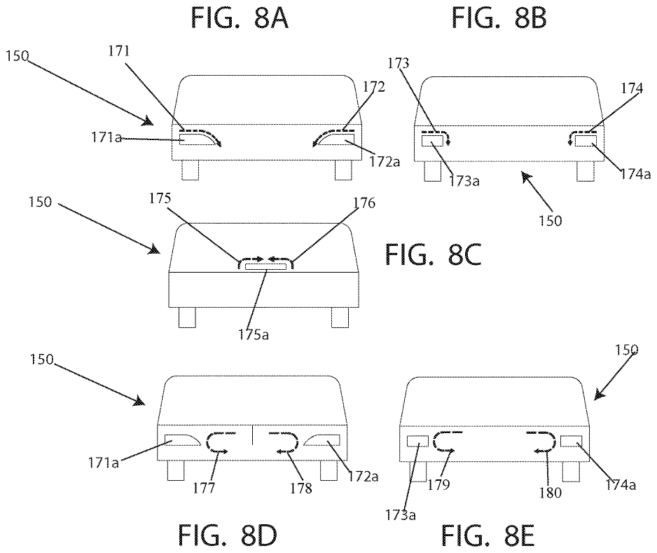

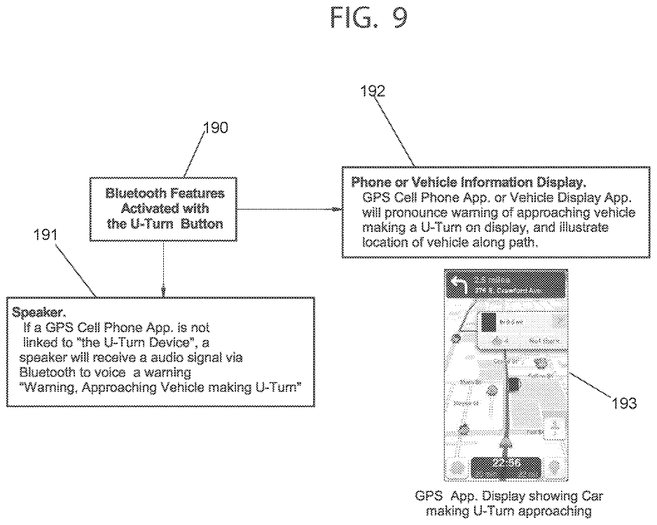

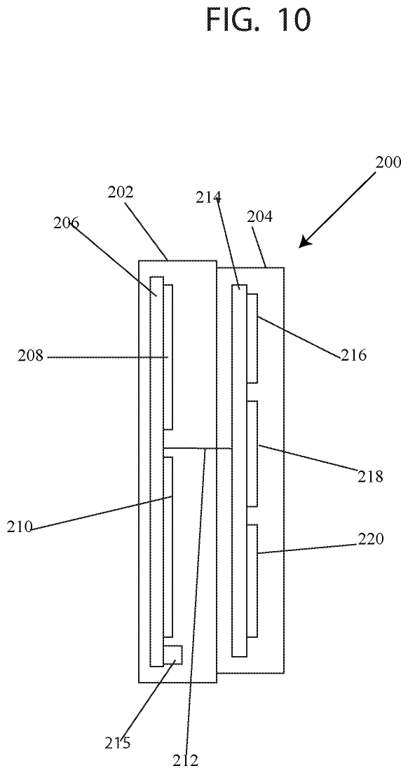

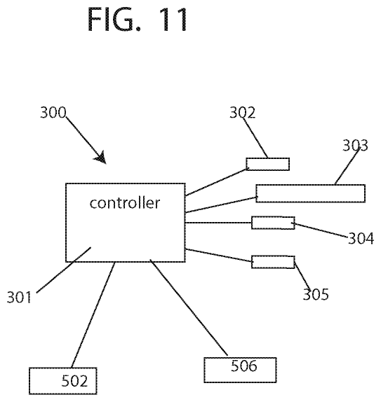

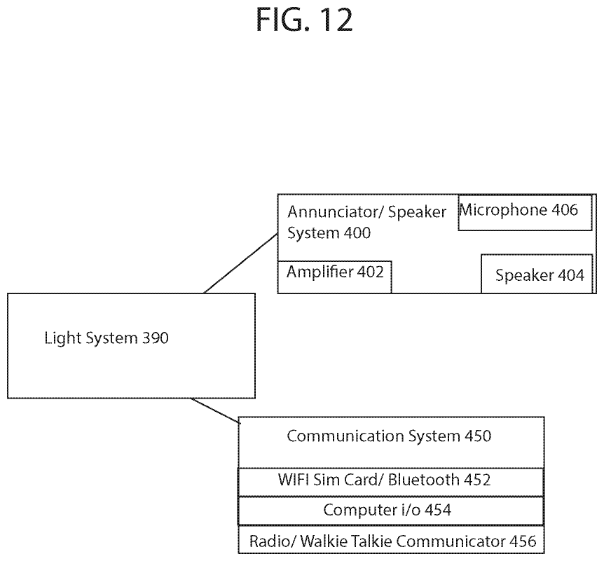

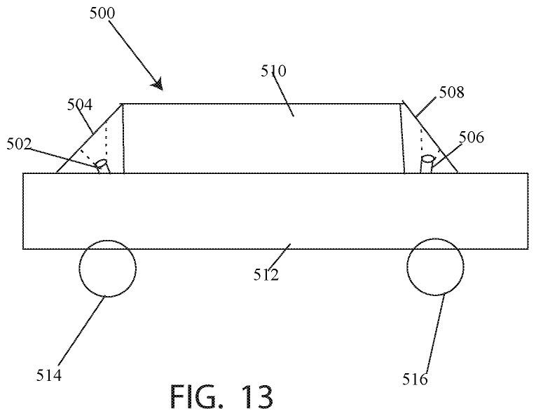

FIG. 1A is a schematic diagram of the circuit of the U-turn indicator 10 which includes a battery of DC power 12 which is grounded at point 14, and which is coupled to a switch 16 in a form of a car or auto ignition switch. There are three lines 17, 19, and 21, each having respective fuses 18, 20 and 22. Along the first line 17 is a switch 24 which switches on a left or right U-turn signal. Along the second line 19 is a flasher light 26 which can flash for example as red or blue. Along the third line 21 are two separate electric lamps forming a front car logo 28 and 30 in parallel with each other and terminating at respective ground ends 29 and 31 respectively. A relay 32 is coupled downstream from the first line 17 and the second line 19, wherein this relay 32 can selectively switch between ports/contacts 32a, 32b, 32c, and 32d. Port 32d terminates at ground 34. Port 32c feeds downstream to left U-turn signal 36. Port 32b feeds into a second relay 38. Second relay 38 includes ports/contacts 38a, 38b, 38c and 38d. Port 38d feeds into a ground, while port 38c feeds into the right arrow U-turn signal 50 along line 35. Left U-turn signal 36 includes the following components a left U-turn arrow light 37, a left U-turn climbing light 44 and a strobe light 42 wherein these components are all parallel to each other with the left U-turn arrow light and the left U-turn climbing light terminating with ground 46 while strobe light 42 terminates with ground 48. Right U-turn signal 50 includes right U-turn arrow light 51, a right U-turn climbing light 54 and a logo strobe light 52 coupled in parallel with light 51 and light 54. Strobe light 52 terminates with ground 58. Lights 51 and 54 terminate with ground 56. When the Left U-turn signal 36 is lit via activation of port 32c the left turn arrow light is lit, the left U-turn climbing light is lit 54 and the strobe light 52 is also lit as well. When the right U-turn light 50 is lit, port 38c is activated wherein the right U-turn arrow light 51 is lit, the right U-turn climbing light 54 is lit and the strobe light 52 is also lit. FIG. 1B is a diagram of the electrical connector 60 of the U-turn indicator, this electrical connector is coupled into a main panel of an automobile and includes the following components, a housing 61.11 a first contact 86, a second contact 83, a third contact 85 and a fourth contact 87. Contact 86 is a white contact, contact 87 is a yellow contact and contact 85 is a black contact. Similarly, FIG. 1C is a view of a power supply 12 which has a grounded contact or point 14 wherein this power supply 12 feeds into a switch 16. Downstream from the switch 16 are respective fuses 18, 20, 22 and 23a. There are also lines 17, 19, 21 and 23b. Line 17 feeds into switch 24. Line 19 feeds into flasher 26. Line 21 feeds into either the front car logo 28 or the rear car logo 30. Line 23b feeds into receiver 60. Receiver 60 feeds into speaker 61 which is an annunciator for indicating the car is going into a U-turn. This speaker is grounded to a line 61b. Switch 24 feeds into lines 24a and 24b, which feeds into transmitter 63 which is grounded via ground 63b. Transmitter 63 sends a radio wave to an approaching car to indicate to the car's intent on making the U-turn. Line 24A feeds into relay 32, while line 24b feeds into relay 38. Relays 32 and 38 are the same as the relays shown in FIG. 1A. Line 19 feeds into a red or blue flasher 26 which also feed into relays 32 and 38. Line 21 feeds into front car logo 28 and strobe light 28a or into rear car logo 30 and strobe light 30a. Relays 32 and 38 feed into respective contacts 64 and 65. Contact 64 has four separate contacts 64a, 64b, 64c, and 64d. Contact 65 has separate contacts 65a, 65b, 65c and 65d. Off of these contacts are left turn signal 36 having red/black indicator lights 37 and red black indicator lights 44 as well as ground 46. Right U-turn flashing arrow light has red/black light 51 as well as red/black arrow light 54 as well as ground 58. There is also a front car logo 28 and a back car logo 40 in communication with line 21. Line T1.7 extends from contact 64d and feeds into strobe light 28a and strobe light 30a as well as into extra flashing U-turn light on dash 27a, as well as into extra flashing U-turn light 27b on the dash. The front car logo 28 and the rear car logo 40 can be activated when a user activates fuse 22 through line 21. FIG. 1D is similar to FIG. 1B which is a diagram of the electrical connector 60.1 of the U-turn indicator, this electrical connector is coupled into a main panel of an automobile and includes the following components, a housing 61.1, a first contact 86, a second contact 83, a third contact 85 and a fourth contact 87. Contact 86 is a white contact, contact 87 is a yellow contact and contact 85 is a black contact. As disclosed above, when the Left U-turn signal 36 is lit via activation of port or contact 32c the left turn arrow light is lit, the left U-turn climbing light is lit 54 and the strobe light 52 is also lit as well. When the right U-turn light 50 is lit, port or contact 38c is activated wherein the right U-turn arrow light 51 is lit, the right U-turn climbing light 54 is lit and the strobe light 52 is also lit. FIG. 2A is a view of the steering wheel and actuator of the U-turn indicator which shows the components 90 including a steering wheel 95 as well as a turn signal arm 100 which can move in a first position 92, a second position 94, a third position 96 and a fourth position 98. The different positions of the lever 100 are used to trip the different fuses in both FIGS. 1A and 1C. For example, in a first position of the lever that of position 92 this trips fuse 18 thereby sending a signal down line 17 to send a radio wave through transmitter 63 to an approaching car. In a second position 94 of the lever this trips fuse 20 to send a signal down line 19 through red flasher 26 to activate relay 32 which then activates left U-turn signal 36. In a third position 96 of the lever this trips fuse 23a which sends a signal down line 23b to receiver 60 to indicate the intention to turn. In a fourth position 98 of lever 100 this trips fuse 20 which sends a signal down line 19 through flasher 26 on to relay 38 which sends a signal through contact 38c to right U-turn flashing arrow light 50. FIG. 2B is a view of the steering wheel and actuator of the U-turn indicator which shows steering wheel 90 and arm 100 as well as turn button 104 which when pressed provides the indication of a person intending to engage in a U-Turn. Essentially the U-turn button 104 can be used to activate the flasher 26 in advance of the turn. This U-turn button can also be used to activate fuse 18 for activating transmitter 63 for transmitting via a radio wave that the driver intends to make a U-turn. This transmission can be both an audible transmission and a Bluetooth signal transmission to transmit a signal to adjacent automobiles. FIG. 3 is the flow chart for the process for actuating the U-turn indicator which shows that in step S1 a user can press or toggle a U-turn button such as U-turn button 104. Next in step S2 it can activate a unique audio click sound for a U-turn and then transmit a signal to approaching cars in step S3 this transmission can be through transmitter 63. During this step it sends a signal via radio wave to activate a warning sound to approaching cars. It would send the radio message “Warning, approaching car making a U-turn. Next, it would send a Bluetooth signal via transmitter 63 to a cell phone or GPS to illustrate the location of the approaching car making a U-turn. Next in step S4 it would activate the U-turn signal light such as dash lights 27a and 27b on the dashboard in step S4. Next, in step S5 it would activate the flashing or stationary lights around the vehicle exterior such as the left turn signal light 36 (including any one of lights 37 and 44) or the right turn signal light 50 including any one of lights 51 and 54. See FIG. 1C. Next, in step S6, upon completion of the U-turn such as when the driver's wheel is turned in an opposite direction, the U-turn signal would turn off. Alternatively, the user could press or toggle the U-turn signal button off. Alternatively, the user could deactivate all U-turn activated features as well in step S8. FIG. 4A is a front view of a U-turn indicator 120 which includes a base or housing 122 and a climbing light section 124 as well as an arrow section 125 inside of a housing 122. FIG. 5A is a first view of a dashboard configuration 131 on a dashboard 130 which includes a of a positioning of a dashboard U-turn indicator 140 wherein an indicator 140 is positioned between a speedometer 134 and a tachometer 132 on a dashboard 130. FIG. 5B is a view of a dashboard configuration 133 wherein the indicator 140 is positioned on a lower portion of a dashboard 133 between speedometer 134 and tachometer 132. FIG. 5C is a third view of a positioning 135 of a dashboard of a U-turn indicator, wherein two indicators 140 and 141 are positioned outside of speedometer 134 and tachometer 132. FIG. 6A is a first view of the positioning of the U-turn indicator on an automobile wherein this indicator 151 is positioned on a back window 152 on an auto 150. FIG. 6B is a second view of a positioning of U-turn indicators 162 and 161 on a license plate 160, wherein these U-turn indicators are positioned on an outside region of the license plate. FIG. 6C is a third view of a positioning of a U-turn indicator wherein two different indicators 153 and 154 are positioned on a back window 152 in the upper right corner and the upper left corner respectively. FIG. 6D is a view of an automobile 150 having a back window 152 with an automobile emblem which can be used to light up to indicate the presence of the automobile. The car emblem is configured with electronics for both strobe pulsing and color change. The strobe pulsing is through the use of a timer chip, while the change in colors is due to the activation of different colored white, red, green and blue LED lights to create a pre-set color. FIG. 7A is another view of a positioning of a U-turn indicator which shows a back window 152 on an auto 150, wherein a first indicator 163 is shown extending up from a left side region of the back window towards a top center region of the window, while a second indicator 164 is shown extending up from a right-side region towards a center region of the back window. FIG. 7B is another view of a positioning of a U-turn indicator, in this case there is an automobile 150 which has a first U-turn arrow 165 and a second U-turn arrow 166. First U-turn arrow 165 extends up from a back frame section 168, while second U-turn arrow 166 extends up from a front frame section 169. FIG. 7C is another view of a positioning of a U-turn indicator which shows arrows 167 and 168 on side sections of a front or a rear window 152 of an automobile. FIG. 8A is another view of a positioning of a U-turn indicator wherein indicator 171 is positioned adjacent to a front headlight 171a while indicator 172 is positioned adjacent to headlight 172a on auto 150. FIG. 8B is another view of a positioning of a U-turn indicator 173 adjacent to a tail light 173a while indicator 174 is positioned adjacent to tail light 174a on auto 150. There is also in FIG. 8C indicators 175 and 176 positioned adjacent to rear light 175a. FIG. 8D is another view of a U-turn indicator wherein indicator 177 is adjacent to headlight 171a while indicator is positioned adjacent to headlight 172a wherein indicators 177 and 178 are between headlights 171a and 172a. FIG. 8E is another view of a U-turn indicator, wherein tail light 173a and 174a are shown wherein indicators 178 and 180 are positioned between these taillights 173a and 174a. FIG. 9 is a flow chart for the process for initiating the U-turn indicator. In this view there is shown in step 190 the Bluetooth features are activated with the pressing of a U-turn button such as U-turn button 140. Next, in step 191 a speaker is activated wherein this speaker will indicate a warning of an approaching vehicle making a U-turn. In step 192 an adjacent phone will receive a signal indicating that an adjacent vehicle will be making a U-turn. This can occur via communication between cell phones and through navigation applications on cell phones wherein the cell phones would mark the GPS location and then send a notification to all other cellular based devices based upon their GPS location an indication that an adjacent auto was about to make a U-turn. Step 193 shows this indication of an adjacent car making a U-turn once the user presses the U-turn button 140. FIG. 10 is a view of a housing of a U-turn indicator 200 which can be representative of any one of the U-turn indicators shown above. In this view there is a first housing 202 which houses a motherboard 206 which has coupled to it a processor 208 such as a microprocessor or a controller. There is also a transceiver chip which can be in the form of a wireless communication interface such as Bluetooth and/or cellular communication interface. This motherboard 206 is in communication with a LED board 214 which is configured to house multiple LED lights such as the lights 216, 218 and 220 shown coupled to board 214. There is also a translucent cover 204 which can act as a diffuser which selectively allows the light from lights 216, 218 and 220 to escape from cover 204. Housing 202 also has reflective side walls so that the lights 216, 218 and 220 expels light from this housing. In addition, cover 204 can also have reflective or refractive walls so that it can selectively reflect the light to present the image of a U-shaped or J-shaped indicator which results in the indication of a user making a U-turn. Lights 216, 218 and 220 can be indicative of lights 37, 44 and 42 in FIG. 1A or lights 51, 54 and 52 also shown in FIG. 1A as well. In addition, coupled to motherboard 206 is a speaker 215 which is configured to audibly communicate the intentions of the driver with respect to making a U-turn. While these lights are most commonly located on a front hood or rear window of a vehicle, they can also be located on the roof of an auto, a back of the auto, or such that it shines down into a roadway. Thus, there is created a U-turn indicator which is configured to communicate with adjacent drivers either via visual indication, audio indication, or through telecommunication between portable electronic devices to communicate with adjacent drivers that a driver is engaging in a U-turn, is about to engage in a U-turn or has just completed a U-turn. FIG. 11 is a view of a circuit 300 for use with the system where in there is a controller 301, and a plurality of lights 302, 303, 304, and 305. The controller 301 is configured to selectively switch on or off lights such as lights 302, 303, 304 and 305. Light 302 is a red LED light, light 303 is a white LED light, light 304 is a green LED light and light 305 is a blue LED light. By switching on the different lights in different intensities, it can create customized colors for a colorized effect. For example, a light having greater red effect or a more intense charging of LED 302 (RED LED) this in combination with other lights would create a red shaded light effect. By switching on or changing the intensities of the other lights it allows for the creation of customized lights on an RGB scale. Multiple circuits such as circuit 300 can be placed in place of existing lights such as that shown in FIG. 1 so that instead of a simple white light being shown multiple different colored lights can be shown. For example, this colored circuit 300 can be used in place of lights 216, 218 and 220 shown in FIG. 10. The different colors created can range from Pink to Purple. With the embodiment of FIG. 13, the controller 301 can be in communication with projectors 502 and 506 which are shown in FIG. 13. FIG. 12 is a view of the light system 390 (See U-Turn Indicator 10 FIG. 1) wherein this U-turn indicator is coupled to or in communication with an annunciator or speaker 400 or a communication system 450. The annunciator or speaker system 400 includes an amplifier 402, and a speaker 404 and a microphone. The amplifier 402 is in communication with the speaker 404 so that the annunciator can announce in the auto the intention of the automobile driver to make a U-turn. The speaker can also be positioned to project outside of the automobile so that when the user is intending to make a U-turn it can announce to the autos and other parties around the vehicle that this vehicle is intending to make a U-turn. The microphone 406 is configured to receive input orally from the driver or other passengers so that the U-turn signal can be actuated via a voice command. There is also a communication system 450 which includes a WIFI sim card and/or Bluetooth communication module 452 and/or RFID/NFC Communication Module wherein this module has any one of or each of a WIFI communicator, a SIM CARD, and/or a Bluetooth, RFID/NFC communicator as well. There is also a computer I/O connection, which allows for the light system 390 to be connected to other computers, which allows for communication with the onboard auto computer, as well as any other computer in a wired manner. There is also a radio or walkie talkie communicator 456 which allows for communication of the U-turn via the radio frequency (RF) or optical communications (Optical spectrum uses light as a means of transmitting information via lasers) or via walkie talkie communication. In that way when a user is making a U-turn an automatic announcement can be made over Radio/Walkie Talkie Communicator 456 that a U-turn is being made. This communication is also sent through the other communication channels such as through the computer I/o port 454 and through anyone of the WIFI/SIM Card/Bluetooth/RFID/NFC module 452 so that the intention of turning is conveyed to outside parties. This can occur such as when a turn signal arm 100 is moved or when a U-turn button 104 Is pressed which sends a signal to processor 208 that a turn is being initiated. Thus, this system is configured to communicate with multiple different parties, through WIFI, Bluetooth, RFID/NFC or SIM or Cellular Communication such as through module 452, the system is configured to communicate with phone applications via Cloud (virtual collection of hardware and software resources that make up the communication network topology), Data analytical systems, Data Storage, Notification/Alert system and Artificial Intelligence technologies and mapping programs for example, WAZE®/Google Maps or any other suitable traffic, GPS and/or navigation application. In addition, communication from devices, modules, or applications to vehicle optical and visual systems, including but not limited to: Glass displays via projection, Electromagnetic technology, LED or laser diodes, Lighting technologies embedded in or surrounding vehicles and highways/roads (including electrified roads). FIG. 13 is a view of another mechanism for displaying a U-turn signal either in the front windshield or the back windscreen. In this embodiment 500 three is disclosed an auto 512 having wheels 514 and 516. There is a central cabin 510 which has a front windshield 508 and a back windshield 504. In this embodiment 500 there are projectors 502 and 506. Projector 502 is configured to project an image on back windscreen 504 while projector 506 is configured project onto the back windscreen. Both of these projectors 502 and 506 are in communication with controller 301 shown in FIG. 11. These systems can integrate holographic projection technology, allowing for the display of real-time, three-dimensional (or any) visual information. This can be projected directly onto vehicle glass surfaces, surrounding airspace, or road infrastructure. Holographic displays can enhance communication by offering more immersive, dynamic, and visible alerts or notifications, increasing driver and pedestrian safety and awareness.

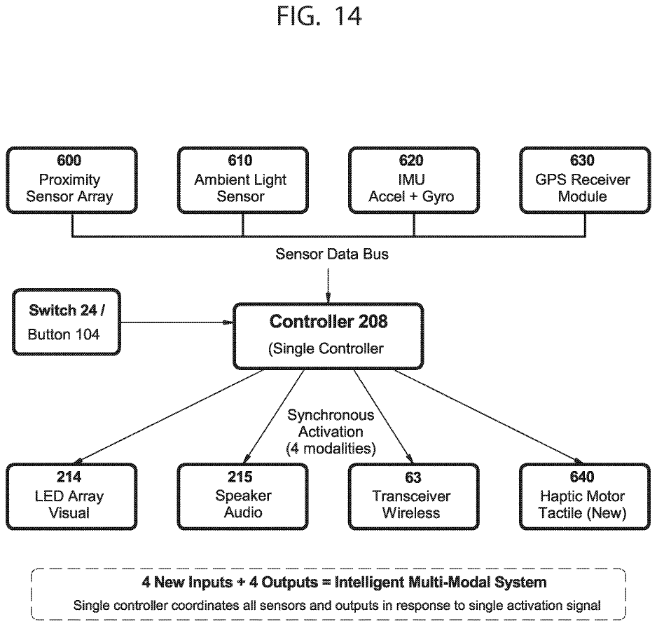

FIGS. 14-19 disclose an integrated system which is designed for signaling and controlling the electronics associated with a U-turn.

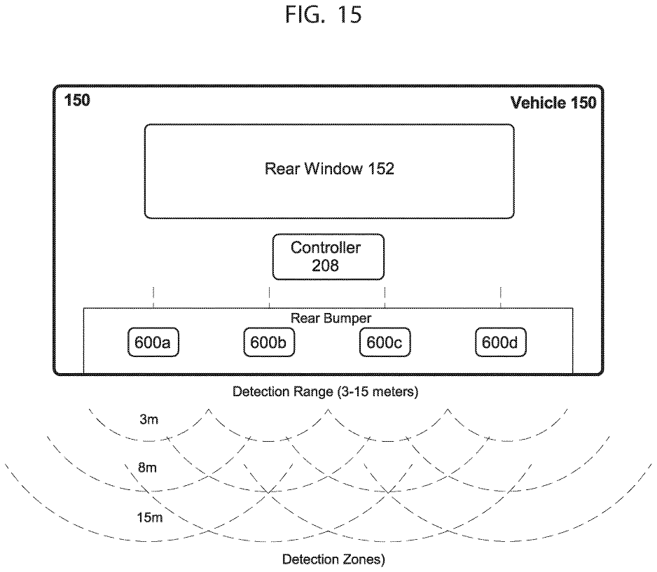

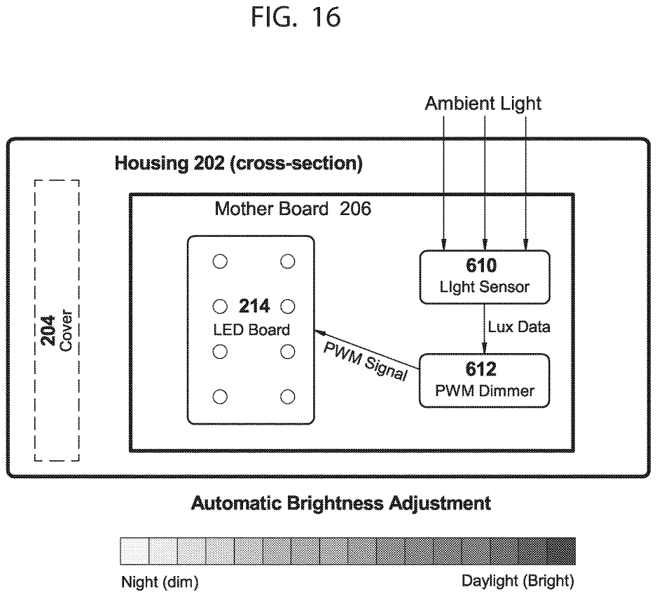

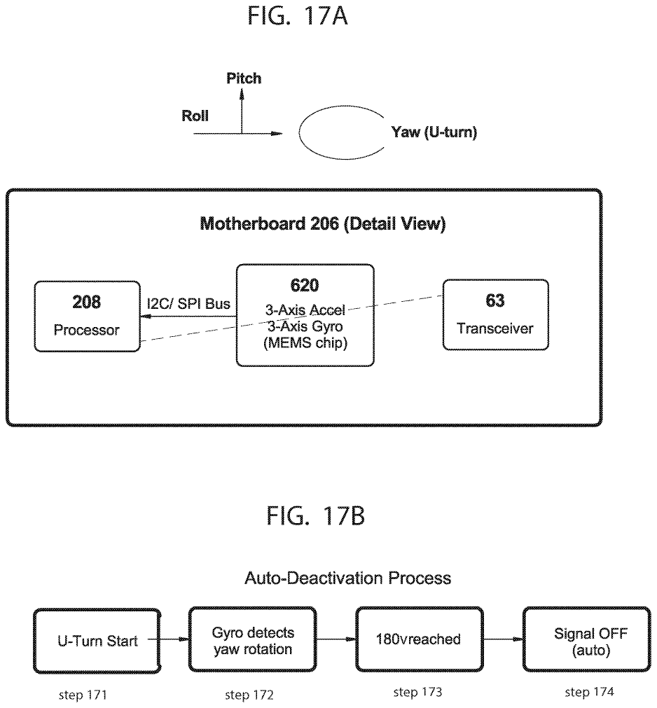

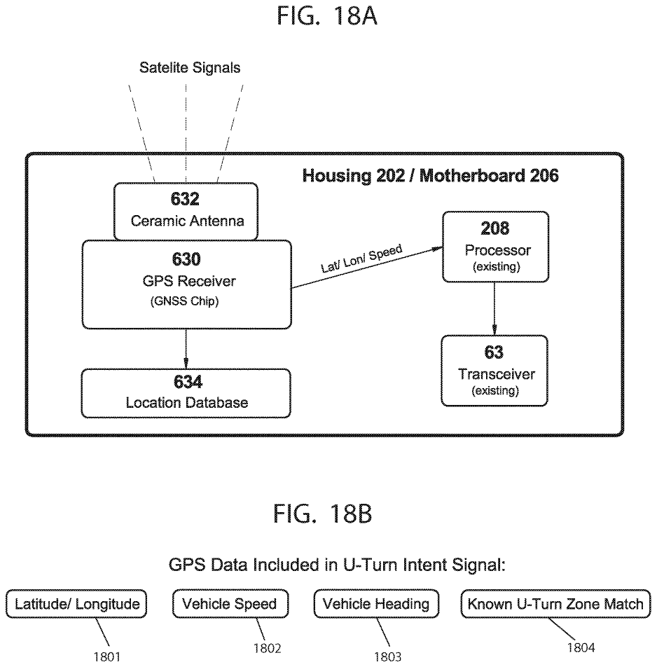

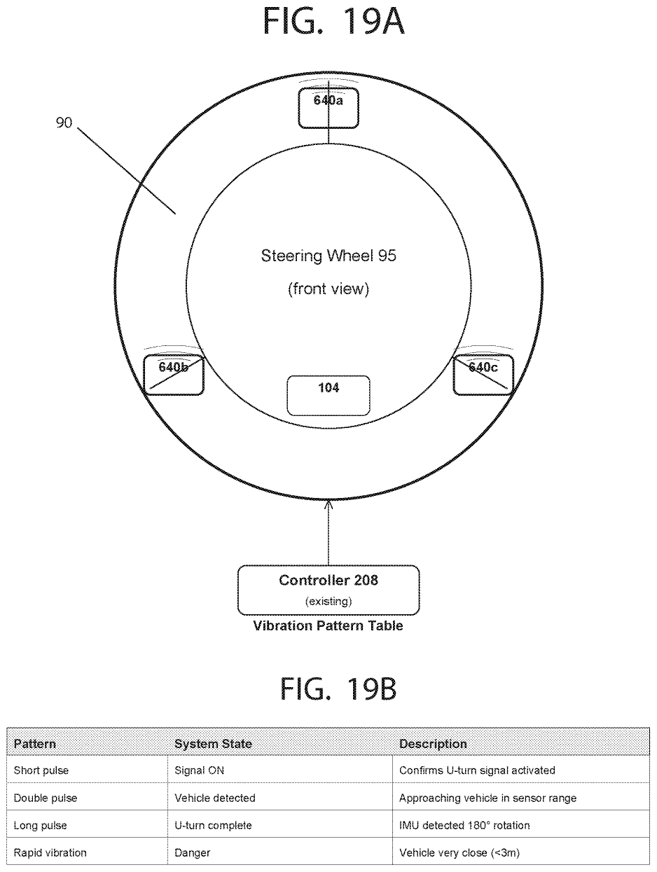

For example, FIG. 14 is a layout of an integrated block diagram showing different components including a proximity sensor which can comprise four ultrasonic transducers or proximity sensors 600, which can include sensors (600a-600d). (See FIG. 15), mounted in the rear bumper. In addition, there is a controller 208 formed as a single controller in communication with the proximity sensor 600. In addition, in communication with the controller 208 is an ambient light sensor 610 (See FIG. 16). There is also an integrated unit 620 comprising an accelerometer or gyroscope, (See FIG. 17) which is in communication with the controller 208. There is also a GPS receiver module 630 (see FIG. 18) in communication with controller 208. A switch or button 24 is in communication with controller 208. Controller 208 is also in communication with LED Visual array 214, or an audio speaker 215, or a wireless transceiver 63, or a haptic motor 640 which can be mounted on a steering wheel (See FIG. 19). Thus, with all of these components there is a controlled U-turn system which provides a customized experience for the user. In this view, there are a proximity sensor 600, an ambient light sensor 610, an IMU 620 (which includes an accelerometer and a gyroscope), and a GPS receiver 630. There is a switch 24 and a button 104 for the controller 208 as well. Controller 208 also includes an LED visual array 214, an audio speaker 215, a wireless transceiver 63, and a haptic motor 640. Thus, there is a disclosed a single controller that coordinates all of the sensors and outputs in response to a single activation signal.

FIG. 15 shows a plurality of proximity sensors 600a, 600b, 600c, and 600d forming fan-shaped detection zones illustrated behind the vehicle. Wiring connections are shown leading to controller 208 inside the cabin. This view shows a vehicle 150 having a rear window 152, a controller 208, and transducers on the rear bumper 600a, 600b, 600c, and 600d. These transducers send out a fan of detection ranges of 3-15 meters which create a detection zone for reading how close any party is to a rear bumper. Thus, these transducers are configured to warn the driver of any person who is close to the rear bumper when the driver is about to initiate a U-turn and warn the driver against making a U-turn before they initiate the turn.

FIG. 16 is a view of an automatic brightness adjustment mechanism which is configured to increase and/or lower the level of brightness in the lights depending on the outside conditions. This view shows a cross-section of a housing having a cover 204, an LED board 214, a light sensor 610, a PWM dimmer 612, all connected to a motherboard 206. This device is also housed in housing 202, having a cover 204. This ambient light sensor mode is configured to change the brightness of the LED board so that the lights can reflect the outside brightness surrounding an automobile. Thus, the U-turn signal can brighten up during daylight hours so that the U-turn is visible.

FIG. 17A is a motherboard detail view for a motion sensor for the U-turn system. This view shows a motherboard 206, a processor 208, a three-axis gyro and accelerometer, and a transceiver 63. This device is configured to turn off the U-turn signal once it has been substantially completed. The three-axis gyroscope and accelerometer 620 (MEMS) is configured to determine the yaw and lean of the automobile to determine how the automobile is leaning or rotating during the U-turn. This gyroscope/accelerometer is then configured to determine the different points through the motions of the car, (rotation, motion etc.) through the U-turn.

For example, in FIG. 17B in step 171, the U-turn starts. Next, in step 172, the Gyroscope 620 detects yaw rotation, this occurs when the auto starts or continues through its U-turn. Next, in step 173, a 180-degree rotation is reached via the vehicle moving through the U-turn. Next, in step 174, the signal (lights) is turned off. This detection is based on the automobile's movement and changes in motion to automatically turn off the U-turn signal.

FIG. 18A is a view of a motherboard which includes a GPS tracking system 630. This view shows housing 202 with motherboard 206. This device includes a ceramic antenna 632, a GPS receiver 630, a location database 634, a processor 208, a MEMS 620, and a transceiver 63. The ceramic antenna is configured to receive satellite signals and deliver them to the GPS receiver. This information is then stored in the location database 634. Next, the processor 208 receives this information and can transmit this information via transceiver 63. This information can also be communicated by MEMS 620. The information conveyed by these components is shown in FIG. 18B, which includes latitude/longitude 1801, vehicle speed 1802, vehicle heading 1803, and known U-turn Zone match 1804. A U-turn zone match is a match that allows matching a U-turn within a region (GPS region) that is a known U-turn zone.

FIG. 19 is a front view of a steering wheel 90. The steering wheel 95 includes a plurality of haptic actuators 640a, 640b, 640c, and a controller 208. When the user is driving using the steering wheel the haptic actuators are configured to activate to provide signals to the user to let the user know the status of the U-turn. For example, when the U-turn is initiated, a short pulse from one of the actuators 640a, 640b, or 640c is sent from controller 208 and lets the user know that the signal is turned on. Alternatively, another signal can be in the form of a double pulse which indicates that a vehicle is detected and is approaching a vehicle in sensor range such as determined by the sensors 600a-600d. Another one of the actuators can indicate a long pulse which indicates that the U-turn is complete wherein this is determined by the MEMS (3 axis accelerometer or gyroscope 620). In addition, one of the actuators 640a, 640b, or 640c can be used to provide rapid vibration to signal danger to the driver. This can occur if another vehicle is very close as found by sensors 600a, 600b, 600c, or 600d.

There is a table shown in FIG. 19B below that shows the different pulse functions described above.

Thus, there is created a U-turn system which includes multiple different components which aid in signaling other parties as well as aid the user in driving the automobile so that the user has advanced notification with respect to the outside surroundings.

Accordingly, while at least one embodiment of the present invention have been shown and described, it is to be understood that many changes and modifications may be made thereunto without departing from the spirit and scope of the invention as defined in the appended claims.

What is claimed is:

1. A moving vehicle (150) turn signal (36) system comprising:
a housing (122, 202);
at least one light (51, 54, 302, 303, 304, 305);
at least one switch (16, 24) to selectively turn on or off said at least one light (51, 54, 302, 303, 304, 305);
at least one display indicating a turn arrow for indicating a U-turn;
at least one controller (32, 38, 64, 65, 208, 301) for activating said switch (16, 24) for selectively switching on said at least one light (51, 54, 302, 303, 304, 305); and
at least one proximity sensor (600) coupled to the automobile (150) configured to determine a location of another adjacent vehicle (150).

2. The moving vehicle (150) turn signal (36) system as in claim 1, wherein said housing (122, 202) has a backing and sides which are reflective and a front surface that is at least partially translucent.

3. The moving vehicle (150) turn signal (36) system as in claim 1, wherein said at least one light (51, 54, 302, 303, 304, 305) is a LED (302) light (51, 54, 302, 303, 304, 305).

4. The moving vehicle (150) turn signal (36) system as in claim 1, wherein said at least one controller (32, 38, 64, 65, 208, 301) is in wired communication with said at least one switch (16, 24).

5. The moving vehicle (150) turn signal (36) system as in claim 1, wherein said at least one controller (32, 38, 64, 65, 208, 301) is in wireless communication with said at least one switch (16, 24).

6. The moving vehicle (150) turn signal (36) system as in claim 1 wherein said at least one display is formed from said at least one light (51, 54, 302, 303, 304, 305) positioned in a substantially J-shape.

7. The moving vehicle (150) turn signal (36) system as in claim 1, wherein the housing (122, 202) is positioned on at least one of the following parts of a motor vehicle (150): a back window (152) of a moving vehicle (150), adjacent to a license plate (160) on a moving vehicle (150); a windshield (504) of a moving vehicle (150); a side panel of the moving vehicle (150), or a fender of the moving vehicle (150).

8. The moving vehicle (150) signal (36) system as in claim 1, further comprising a communication module (452) in communication with said at least one switch (16, 24), wherein when said at least one switch (16, 24) is turned on, it sends a signal (36) to the communication module (452) to announce an intention of a U-turn.

9. The moving vehicle (150) signal (36) system as in claim 8, wherein said communication module (452) further comprises a wireless communication module (452) for wireless communication of when said at least one switch (16, 24) is turned on.

10. The moving vehicle (150) signal (36) system as in claim 8, wherein said communication module (452) further comprises a walkie talkie communicator (456), configured to send an audio signal (36) when said switch (16, 24) is turned on.

11. The moving vehicle (150) signal (36) system as in claim 8, wherein said communication module (452) comprises a wireless communication module (452), RFID/NFC communication module (452), a hard-wired communication module (452), and a walkie talkie communicator (456) for conveying when said switch (16, 24) is turned on.

12. The moving vehicle (150) signal (36) system as in claim 1, further comprising at least one light (51, 54, 302, 303, 304, 305) ambient light (51, 54, 302, 303, 304, 305) sensor (610) in communication with said at least one controller (208, 301) 208, wherein said light (51, 54, 302, 303, 304, 305) ambient light (51, 54, 302, 303, 304, 305) sensor (610) is configured to adjust an intensity of the light (51, 54, 302, 303, 304, 305) based upon an ambient amount of light (51, 54, 302, 303, 304, 305) in a perimeter of the vehicle (150).

13. The moving vehicle (150) signal (36) system as in claim 1, further comprising an accelerometer (620)/gyroscope (620) configured to determine a position of the moving vehicle (150) during operation.

14. The moving vehicle (150) signal (36) system as in claim 1, further comprising at least one GPS receiver (60) (630) module (452) for determining a motion of the moving vehicle (150) during a U-turn.

15. The moving vehicle (150) signal (36) system as in claim 1, further comprising at least one tactile indicator (640a, 640b, 640c) coupled to a steering wheel (90, 95), wherein the tactile indicator (640a, 640b, 640c) is configured to indicate a condition to warn a user against making a U-turn.

16. The moving vehicle (150) signal (36) system as in claim 15, wherein said tactile indicator (640a, 640b, 640c) is configured to warn the user that an adjacent vehicle (150) is too close.

17. The moving vehicle (150) signal (36) system as in claim 15, wherein said tactile indicator (140, 151, 171, 172, 174, 177) indicates that the U-turn is complete.

18. The moving vehicle (150) signal (36) system as in claim 15, wherein the tactile indicator is configured to indicate that the U-turn signal is activated.
